(19) United States
(12) Patent Application Publication
(10) Pub. No.: US 2026/0171678 A1
(43) Pub. Date: Jun. 18, 2026

(54) DEVICE WITH A DIELECTRIC WAVEGUIDE INTERFACE FOR COUPLING BETWEEN AN ANTENNA SYSTEM AND A DIELECTRIC WAVEGUIDE

(71) Applicant: NXP B.V., Eindhoven (NL)

(72) Inventors: Philipp Franz Freidl, Weurt (NL); Pieter Lok, Leur (NL); Johannes Adrianus van Ewijk, Eindhoven (NL); Marco Jan Gerrit Bekooij, Empel (NL)

(21) Appl. No.: 18/984,010

(22) Filed: Dec. 17, 2024

(51) Int. Cl. H01Q 21/00; H01Q 1/40; H01Q 21/06

(52) U.S. Cl. CPC H01Q 21/0068; H01Q 1/405; H01Q 21/065

(57) ABSTRACT

Devices with a dielectric waveguide interface for coupling between an antenna system and a dielectric waveguide are disclosed. In an example, a device includes a housing that forms an enclosed space, an antenna system within the enclosed space, and a dielectric waveguide interface configured to couple a dielectric waveguide to the housing without compromising the housing.

### BACKGROUND

Distributed radar systems are used for automotive sensing to detect objects in a vehicle's field of view. In such radar systems, a radio frequency (RF) front end component that includes RF antennas may be enclosed in a sealed housing that includes a radome. Additionally, it may be desirable to be able to calibrate a radar system using a known target. Calibration of a radar system may involve coupling signals to and from the RF front end component with another sensor via a dielectric waveguide such as a polymer fiber (PMF) that is connected to the radar system in close proximity to antennas of the RF front end. While it is important to be able to calibrate a radar system, it is also important to maintain the integrity of the housing that encloses the RF antennas.

### SUMMARY

Devices with a dielectric waveguide interface for coupling between an antenna system and a dielectric waveguide are disclosed. In an example, a device includes a housing that forms an enclosed space, an antenna system within the enclosed space, and a dielectric waveguide interface configured to couple a dielectric waveguide to the housing without compromising the housing.

In an example, the dielectric waveguide interface includes a receptacle in the housing, wherein the receptacle is configured to receive the dielectric waveguide.

In an example, the dielectric waveguide interface includes a receptacle in the housing that is shaped similar to the dielectric waveguide.

In an example, the housing includes a base coupled to a radome and wherein the dielectric waveguide interface includes a receptacle in the radome, wherein the receptacle is configured to receive the dielectric waveguide.

In an example, the device further includes a coupling structure configured to enhance electromagnetic energy coupling between the dielectric waveguide interface and the antenna system.

In an example, the device further includes a plurality of structural elements in the housing that are symmetrically positioned relative to the antenna system.

Another example of a device includes a housing including a base and a radome coupled to the base, wherein the base and the radome form an enclosed space, an antenna system within the enclosed space, and a dielectric waveguide interface that is integrated with the housing and configured to receive a dielectric waveguide without compromising the housing.

In an example, the dielectric waveguide interface includes a receptacle in the housing.

In an example, the dielectric waveguide interface includes a receptacle in the housing that is shaped and sized to receive a dielectric waveguide.

In an example, the dielectric waveguide interface includes a receptacle in the radome.

In an example, the dielectric waveguide interface includes a receptacle in the radome that is shaped and sized to receive an end of a dielectric waveguide.

In an example, the device further includes an electromagnetic energy coupling structure integrated with the housing.

In an example, the device further includes an electromagnetic energy coupling structure integrated with the radome.

In an example, the electromagnetic energy coupling structure includes a plurality of structural elements in the housing that are symmetrically positioned relative to the antenna system.

Another example of a device includes a base, an antenna system coupled to the base, and a radome coupled to the base, wherein the base and the radome form an enclosure around the antenna system, wherein the radome includes a dielectric waveguide interface configured to receive a dielectric waveguide without compromising the radome.

In an example, the dielectric waveguide interface includes a receptacle in the radome.

In an example, the receptacle includes a cavity within the radome that is configured to receive an end portion of a dielectric waveguide.

In an example, the radome further includes an electromagnetic energy coupling structure configured to enhance electromagnetic energy coupling between the antenna system and the dielectric waveguide interface.

In an example, the radome includes at least one additional structural element that is symmetrically positioned relative to the electromagnetic energy coupling structure and to the antenna system.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1A is a side view of a device that includes a base, a dome shaped radome, an antenna system and a dielectric waveguide interface.

FIG. 1B is a top view of the device of FIG. 1A.

FIG. 1C is a side view of the device of FIG. 1A.

FIG. 1D is a side view of a device similar to the device of FIGS. 1A-1C that includes at least one coupling structure.

FIG. 1E is a top view of the device of FIG. 1D.

FIG. 2A is a side view of a device that includes a base, a planar shaped radome, an antenna system and a dielectric waveguide interface.

FIG. 2B is a top view of the device of FIG. 2A.

FIG. 2C is a side view of the device of FIG. 2A.

FIG. 2D is a side view of a device similar to the device of FIGS. 2A-2C that includes at least one coupling structure.

FIG. 2E is a top view of the device of FIG. 2D.

FIG. 2F is a perspective view of a device similar to the device of FIGS. 2D and 2E that shows a coupling structure.

FIG. 3A is a side view of a device that includes a base, a planar shaped radome, an antenna system and a dielectric waveguide interface at a sidewall of the radome.

FIG. 3B is a top view of the device of FIG. 3A.

FIG. 3C is a side view of the device of FIG. 3A.

FIG. 4A is a side view of a device that includes a base, a planar shaped radome, an antenna system and a dielectric waveguide interface at a sidewall of the radome.

FIG. 4B is a top view of the device of FIG. 4A.

FIG. 4C is a side view of the device of FIG. 4A.

FIG. 5A is a side view of a device that includes a base, a planar shaped radome, an antenna system and a dielectric waveguide interface at a top planar surface of the radome.

FIG. 5B is a top view of the device of FIG. 5A.

FIG. 6 is a functional block diagram of an example of components that may be included in a device as with reference to FIGS. 1A-5B.

FIG. 7A depicts a perspective view of a base and an antenna system without a radome attached to the base.

FIG. 7B is a perspective view of a device in which a radome is attached to the base shown in FIG. 7A.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

The description provided herein refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

Some techniques for coupling a dielectric waveguide to an RF system may involve the dielectric waveguide passing completely through a radome of the RF system to bring the dielectric waveguide very close to antennas of the RF system. However, having the dielectric waveguide pass completely through the radome can compromise the integrity of the housing. It has been realized that a dielectric waveguide can be coupled to the housing of an RF system without compromising the housing to, for example, enable calibration of the RF system. In an example, a device includes a base, an antenna system coupled to the base, a radome coupled to the base, wherein the base and the radome form an enclosure around the RF antenna system and the radome includes a dielectric waveguide interface configured to receive a dielectric waveguide without compromising the radome. In an example, the dielectric waveguide interface includes a receptacle in the radome that does not compromise the enclosure around the RF antenna system. In addition to coupling the dielectric waveguide to the radome, it may be desirable to include at least one feature in the radome that enhances the coupling of electromagnetic energy between the antenna system and the dielectric waveguide.

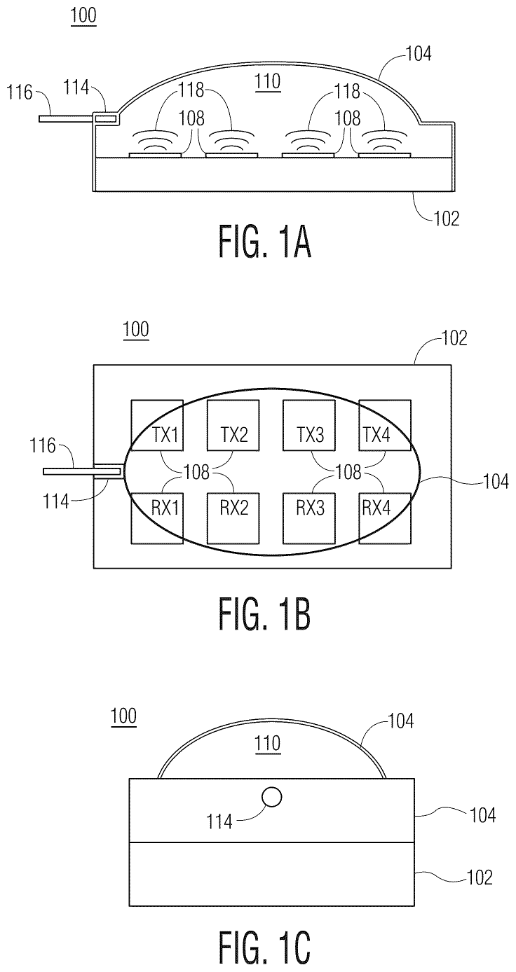

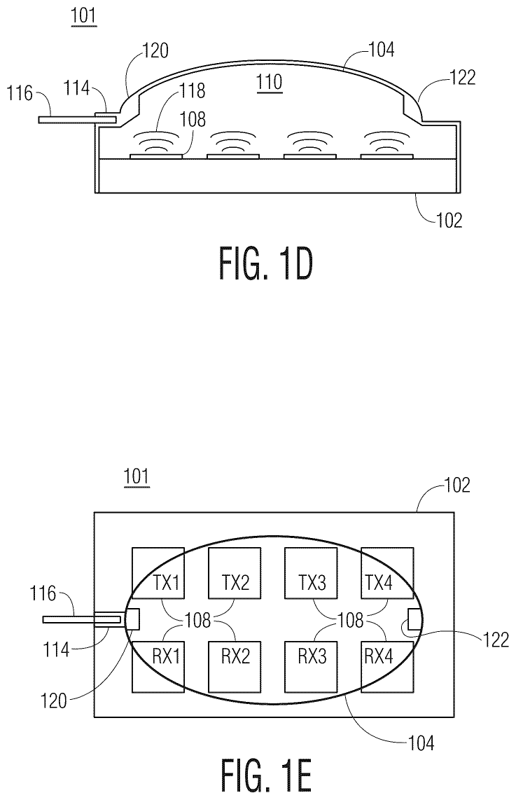

FIGS. 1A-1C depict an example of a device 100 that includes a housing (e.g., formed by a base 102 and a radome 104), an antenna system (e.g., including antennas 108) within an enclosed space 110 formed by the housing, and a dielectric waveguide interface 114 that is integrated with the housing to couple electromagnetic energy between the antenna system and a dielectric waveguide 116 that is coupled to the dielectric waveguide interface without compromising the housing. In particular, the dielectric waveguide interface does not compromise the housing in that the dielectric waveguide interface does not form an opening completely through the housing (e.g., completely through the radome) that would allow contaminants (e.g., a gas (e.g., air), dust particles, a liquid (e.g., water)) to penetrate into the enclosed space from the surrounding environment. For example, the dielectric waveguide interface is configured such that a dielectric waveguide does not penetrate into the enclosed space when secured into the dielectric waveguide interface. In this way, a dielectric waveguide secured to the dielectric waveguide interface is external to the enclosed space formed by the base and the radome. The dielectric waveguide interface physically secures the dielectric waveguide to the radome of the housing and enables electromagnetic coupling through the dielectric waveguide interface 114 between the dielectric waveguide and the antenna system. FIG. 1A is a side view of the device at a long side of the device, FIG. 1B is a top view of the device, and FIG. 1C is a side view of the device at a short side of the device. In an example, the dielectric waveguide is coupled to a transceiver that is configured to receive analog signals that are coupled to the dielectric waveguide via the dielectric waveguide interface. The transceiver may be connected to a processor, or processors, that process the analog signals in an analog domain and/or a digital domain. In an example, analog signals correspond to radar signals of a radar system.

With reference to FIG. 1A, the housing of the device 100 is formed by the base 102 and the radome 104 that is coupled to the base. In an example, the base includes a body structure, such as a metal or plastic body structure and a circuit board or boards that include various electric components such as RF front end components, communications components, and power management components. The circuit board, or circuit boards, may be secured on or in the body structure of the base. An antenna system is coupled to the base and the antenna system may include multiple antennas 108, such as an array of patch or microstrip antennas. FIG. 1A also illustrates electromagnetic energy 118 emanating from the antennas of the antenna system to highlight that the structures are antennas. The top view of FIG. 1B shows an array of four transmit antennas (e.g., TX1, TX2, TX3, TX4) and four receive antennas (e.g., RX1, RX2, RX3, RX4). Although the antenna system includes four transmit antennas and four receive antennas, other numbers and configurations of antennas are possible.

The radome 104 is a protective enclosure element that is designed to shield the antenna system from environmental factors (e.g., water, dust, dirt, mud) without interfering with signal transmission. Radomes are commonly dome-shaped, providing a rounded, weather-resistant cover that reduces drag and protects sensitive radar equipment from physical damage and from elements such as rain and ice. Radomes may be mode of, for example, plastic, fiberglass, or a composite material such as a polytetrafluoroethylene (PTFE) coated fabric. In another example, planar radomes have a flat, panel-like design and are often used where space or shape constraints exist. The radome shown in FIGS. 1A-1C is coupled to the base 102 to form the enclosed space 110. The radome may be coupled to the base by, for example, mechanical connectors (e.g., screws and/or complementary attachment features on the base and radome), adhesive, or some combination thereof. The coupling between the base and the radome may include additional elements such as a gasket to help form a watertight seal between the base and the radome. In an example, the base is coupled to the radome in a manner that creates a sealed enclosure that is watertight such that water and/or other particles are not able to enter the enclosed space. In sensing systems such as automotive radar, it is important to keep the enclosed space free from outside elements such as water and dirt to ensure consistent sensing. Thus, the enclosed space formed between the radome and the base helps to maintain a controlled environment for the antenna system that shields the antenna system from physical damage while allowing for electromagnetic wave transmission, which is critical for effective radar functionality.

As described above, the dielectric waveguide interface 114 is integrated with the housing without compromising the housing so that a dielectric waveguide that is secured to the dielectric waveguide interface does not penetrate through the enclosure around the antenna system. In the example of FIGS. 1A-1C, the dielectric waveguide interface is integrated into a sidewall of the radome 104, and the dielectric waveguide interface includes a receptacle that is sized and shaped to receive an end portion of a dielectric waveguide 116. The receptacle includes an opening that extends from an outer surface of the radome toward (but not to) an interior surface of the radome. In an example, the receptacle is a cavity in the exterior surface of the radome that does not pass entirely through the radome and that is configured to receive an end portion of the dielectric waveguide. In an example, the cavity has a depth that is about 2-3 times the diameter of the dielectric waveguide. For example, for a dielectric waveguide that has a diameter of 1 millimeter (mm), the cavity would have a diameter of slightly greater than 1 mm (e.g., 1.05 mm) and a depth of 2-3 mm. In the case in which the dielectric waveguide is a PMF having a round cross-section, the receptacle is sized and shaped to receive the PMF such that the PMF fits snugly within the receptacle. Likewise, in the case in which the dielectric waveguide is a PMF having a rectangular (e.g., square) cross-section, the receptacle is sized and shaped to receive the PMF such that the PMF fits snugly within the receptacle. Dielectric waveguides with other cross-sectional shapes are possible, and a receptacle configured to receive a differently-shaped dielectric waveguide would be shaped accordingly. In an example, the receptacle has a depth dimension that is about 2-3 times the diameter of the dielectric waveguide, although the receptacle can be configured with a different depth dimension. The portion of the dielectric waveguide that is received by the receptacle may depend on, for example, whether or not an adhesive or attachment mechanism (e.g., a clip) is used to secure the dielectric waveguide within the receptacle. Regardless of how much of the dielectric waveguide is fit within the receptacle, the receptacle does not form an opening completely through the radome through which contaminants (e.g., air, dust, water) could pass from an external environment to the enclosed space. Thus, the dielectric waveguide interface does not compromise the radome, e.g., does not compromise the integrity of the radome. That is, the dielectric waveguide interface is integrated with the radome such that the dielectric waveguide interface shields the enclosed space from the dielectric waveguide, and the dielectric waveguide does not penetrate into the enclosed space that is formed by the base and the radome, which could allow contaminants (e.g., air, dust, water) from the outside environment to enter the enclosed space.

In an example, the diameter or cross-section of the dielectric waveguide 116 is dependent on the operating frequency of the system and/or the properties of the material of the dielectric waveguide. In an example of a radar system that operates at 77 gigahertz (GHz), a dielectric waveguide may have a diameter of around 1 mm. A dielectric waveguide such as a PMF may be coated with an insulating material, which increases the overall diameter, e.g., to around 1 centimeter (cm). Although an example of a dielectric waveguide is provided, dielectric waveguides having other cross-section shapes and sizes are possible.

The dielectric waveguide interface 114 physically secures the dielectric waveguide 116 to the housing (e.g., formed by the base 102 and the radome 104) and enables electromagnetic energy to be coupled between the antenna system and the dielectric waveguide, e.g., from the antenna system to the dielectric waveguide and/or from the dielectric waveguide to the antenna system. The coupling of electromagnetic energy between the antenna system and the dielectric waveguide is important to enable the transfer of signals between the antenna system and the dielectric waveguide for system calibration. In some examples, an additional feature or features may be integrated with the housing to enhance the coupling of electromagnetic energy between the antenna system and the dielectric waveguide. In an example, a feature includes a structure that is integrated into the housing and that is intended to enhance coupling of electromagnetic energy between the antenna system and the dielectric waveguide. Examples of structures that are integrated into the housing and that may enhance coupling of electromagnetic energy between the antenna system and the dielectric waveguide include thicker portions of the radome, design features of the base (e.g., features designed into a circuit board of the base), and/or elements mounted on the base or radome.

FIGS. 1D and 1E are a side view and a top view, respectively, of a device 101 similar to FIGS. 1A-1C in which the radome 104 also includes at least one coupling structure 120 integrated into the radome. With reference to FIG. 1D, the coupling structure may include a section of the radome that is thicker than the rest of the radome and designed to enhance the coupling of electromagnetic energy between the antenna system and the dielectric waveguide. In addition to a coupling structure that enhances the coupling of electromagnetic energy between the antenna system and the dielectric waveguide, the radome may include at least one additional coupling structure 122 that may be configured to, for example, promote signal symmetry within the device.

With reference to FIG. 1E, the top view further illustrates the locations and extent of the two coupling structures 120 and 122. In the example of FIGS. 1D and 1E, the two coupling structures are formed from thicker portions of the material of the radome 104. In an example, the radome 104, the dielectric waveguide interface 114, and the coupling structures 120, 122 are “integrally formed together” by being embodied in a monolithic piece of plastic that is formed by injection molding. In the example of FIGS. 1D and 1E, the coupling structures are integrated with the radome in a symmetrical configuration relative to the antennas of the antenna system as symmetry of the coupling structures may promote signal sensing. In another example, the coupling structures 120 and 122 are symmetrical relative to x and y axis of the radome that each pass through the geometric center of the radome. Although an example of coupling structures is described with reference to FIGS. 1D and 1E, other configurations of a coupling structure, or coupling structures are possible. For example, other coupling structures may be integrated into the housing to enhance electromagnetic energy coupling between the antenna system and the dielectric waveguide and/or to promote symmetry relative to the antenna system.

In another example, a coupling structure may include a coating that acts as a mirror to reflect electromagnetic energy. For example, a coupling structure may include a coating (e.g., a metallic reflective coating) on a surface of the radome (e.g., on an inside surface of the radome) to promote the reflection of electromagnetic energy.

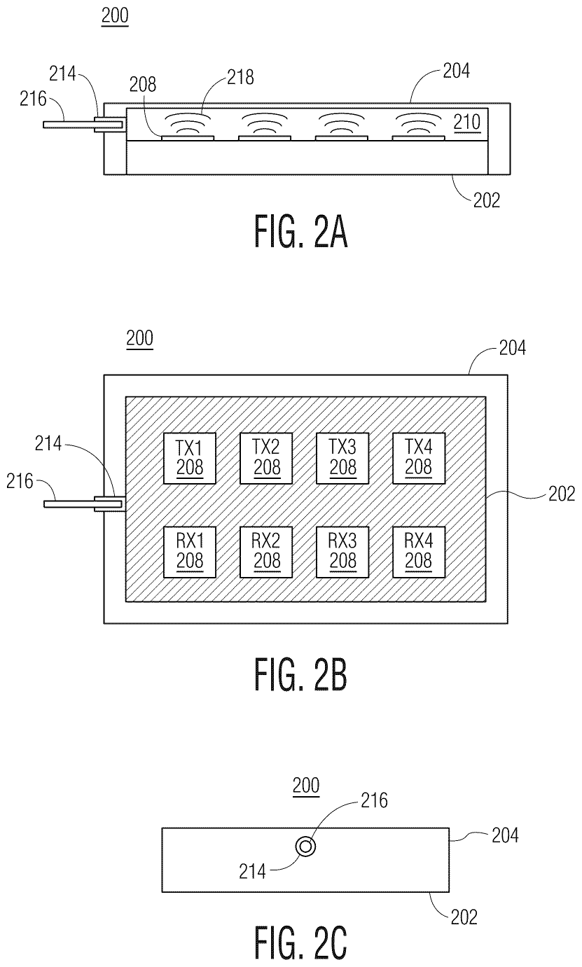

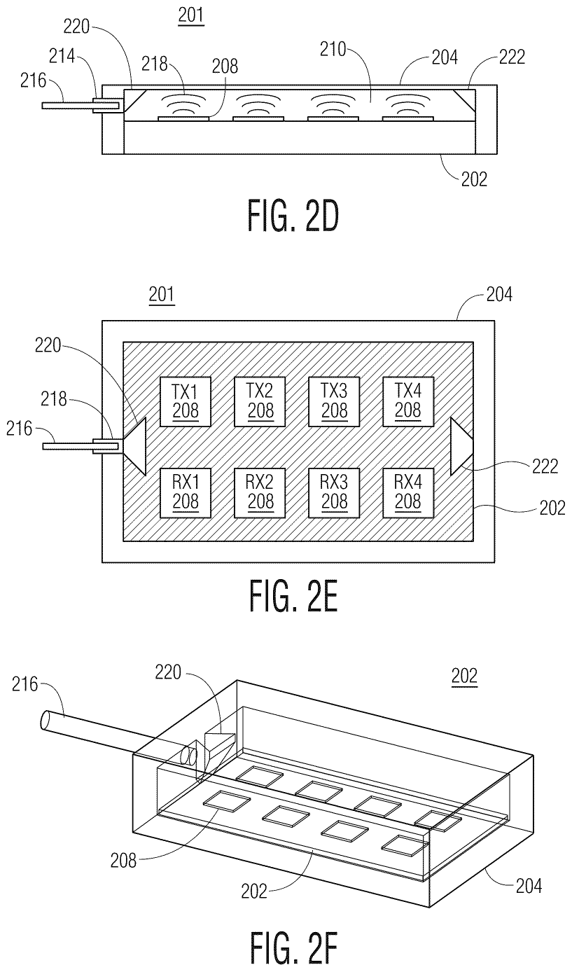

FIGS. 1A-1E depict examples of devices 100 and 101 in which the radome 104 of the housing has a dome shape. FIGS. 2A-2E depict examples of devices 200 and 201 in which the radome 204 has a planar shape. FIG. 2A is a side view of the device 200 at a long side of the device, FIG. 2B is a top view of the device, and FIG. 2C is a side view of the device at a short side of the device.

In the example of FIGS. 2A-2C, the dielectric waveguide interface 214 of the device 200 is integrated into a sidewall of the radome 204 in the form of a receptacle that is sized and shaped to receive an end portion of a dielectric waveguide 216. The receptacle includes an opening that extends from an outer surface of the radome toward (but not to) an interior surface of the radome, and the receptacle is configured to receive an end portion of a dielectric waveguide. In the case in which the dielectric waveguide is a PMF having a round cross-section, the receptacle is sized and shaped to receive the PMF such that the PMF fits snugly within the receptacle. Likewise, in the case in which the dielectric waveguide is a PMF having a rectangular (e.g., square) cross-section, the receptacle is sized and shaped to receive the PMF such that the PMF fits snugly within the receptacle. The top view of FIG. 2B depicts the configuration of the antennas 208 of the antenna system and the side view of FIG. 2C depicts the shape of the receptacle and the cross-sectional shape of the corresponding dielectric waveguide that is coupled within the receptacle. The dielectric waveguide interface physically secures the dielectric waveguide to the radome of the housing without compromising the radome and such that the dielectric waveguide does not penetrate the enclosed space, while enabling electromagnetic coupling between the dielectric waveguide and the antenna system. FIG. 2A also illustrates electromagnetic energy 218 emanating from the antennas of the antenna system to highlight that the structures are antennas.

The dielectric waveguide interface 214 described with reference to FIGS. 2A-2C physically secures the dielectric waveguide to the radome 204 and enables electromagnetic energy to be coupled between at least one antenna 208 of the antenna system and the dielectric waveguide 216. FIGS. 2D and 2E are a side view and a top view, respectively, of the device 201, which is similar to the device 200 of FIGS. 2A-2C, in which the radome also includes at least one coupling structure 220 integrated into the radome.

With reference to FIG. 2D, the coupling structure 220 may include at least one section of the radome 204 that is thicker than the rest of the radome and designed to enhance electromagnetic coupling between the antenna system and the dielectric waveguide. The radome may also include an additional coupling structure 222 that is configured to promote symmetry of the signals within the device. In the example of FIGS. 2D and 2E, the coupling structures 220 and 222 are integrated with the radome in a symmetrical configuration relative to the antennas of the antenna system as symmetry of the coupling structures may promote signal sensing. In another example, the coupling structures 220 and 222 are symmetrical relative to x and y axis of the radome that each pass through the geometric center of the radome.

With reference to FIG. 2E, the top view of the device 201 further illustrates the locations and extent of the two coupling structures 220 and 222. In the example of FIGS. 2D and 2E, the two coupling structures are formed from thicker portions of the material of the radome 204. In an example, the radome, the dielectric waveguide interface 214, and the coupling structures 220, 222 are “integrally formed together” by being embodied in a monolithic piece of plastic that is formed by injection molding. Although an example of coupling structures is described with reference to FIGS. 2D and 2E, other configurations of a coupling structure, or coupling structures are possible. For example, other coupling structures may be integrated into the housing to enhance electromagnetic energy coupling between the antenna system and the dielectric waveguide.

FIG. 2F is a perspective view of a device similar to the device of FIGS. 2D and 2E that shows a coupling structure 220. As shown in FIG. 2F, the coupling structure is a structure that protrudes from an interior surface of the radome 204 into the enclosed space 210 formed between the radome and the base. In the example, the coupling structure 220 is formed from the same material as the radome and can be formed in a single process, such as an injection molding process. Although not shown if FIG. 2F, the device shown in FIG. 2F may include another coupling structure opposite the coupling structure 220, similar to that shown in FIGS. 2D and 2E.

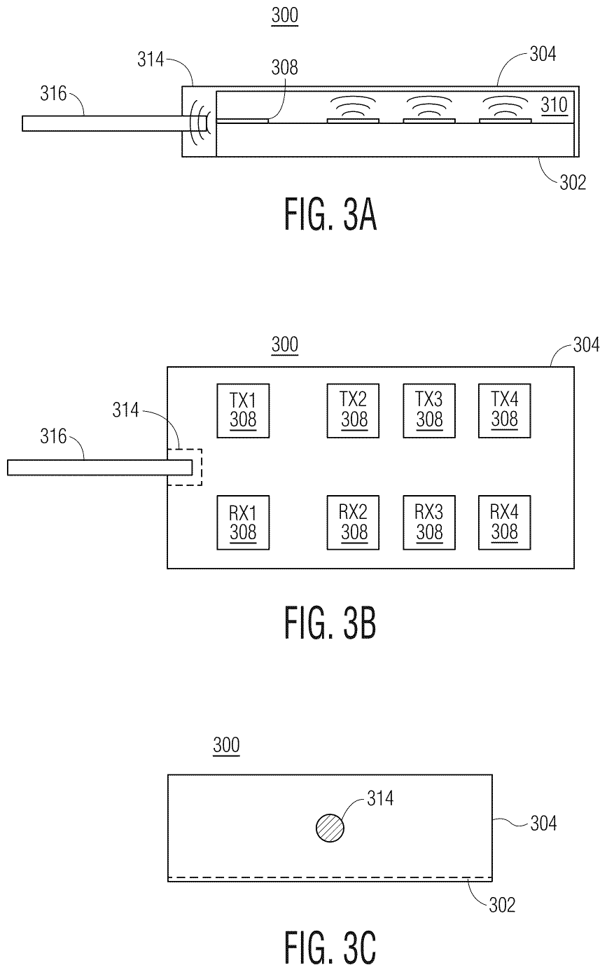

FIGS. 3A-3C depict an example of a device 300 in which the dielectric waveguide interface 314 is integrated into a side wall of a radome 304 and in which at least one antenna 308 (e.g., an endfire antenna) is configured to radiate in the plane of the base 302. FIG. 3A is a side view of the device at a long side of the device, FIG. 3B is a top view of the device, and FIG. 3C is a side view of the device at a short side of the device. In the example of FIGS. 3A-3C, the dielectric waveguide interface includes a block portion of the radome that includes a receptacle configured to receive an end portion of a dielectric waveguide 316. The receptacle includes an opening that extends from an outer surface of the radome toward (but not to) an interior surface of the radome, and the receptacle is configured to receive an end portion of a dielectric waveguide. Additionally, the dielectric waveguide interface is configured so that, when the dielectric waveguide is inserted into the dielectric waveguide interface 314, the dielectric waveguide is parallel to a plane of the antenna system and the base 302 similar to the examples described with reference to FIGS. 1A-1E and 2A-2E. The top view of FIG. 3B depicts the configuration of the antennas 308 of the antenna array and the side view of FIG. 3C depicts the shape of the receptacle and the corresponding cross-sectional shape of the dielectric waveguide that is coupled within the receptacle. The dielectric waveguide interface physically secures the dielectric waveguide to the radome of the housing without compromising the radome such that the dielectric waveguide does not penetrate into the enclosed space 310 formed by the base while the radome and enables electromagnetic coupling between the dielectric waveguide and the antenna system.

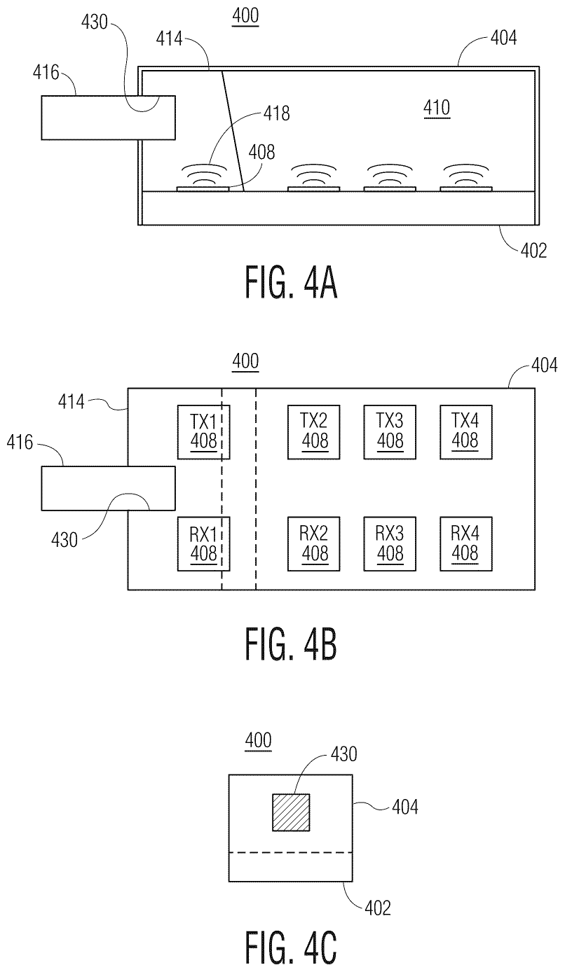

FIGS. 4A-4C depict another example of a device 400 in which the dielectric waveguide interface 414 is integrated into a side wall of a radome 404. FIG. 4A is a side view of the device at a long side of the device, FIG. 4B is a top view of the device, and FIG. 4C is a side view of the device at a short side of the device. In the example of FIGS. 4A-4C, the dielectric waveguide interface includes a block portion of the radome that completely covers (e.g., formed directly on top of) the nearby antennas 408 (e.g., TX1 and RX1) and that includes a receptacle 430 that includes an opening that extends from an outer surface of the radome toward (but not to) an interior surface of the radome, and the receptacle is configured to receive an end portion of a dielectric waveguide. Additionally, the dielectric waveguide interface is configured so that the dielectric waveguide is parallel to a plane of the antenna system and the base similar to the examples described with reference to FIGS. 1A-1E and 2A-2E. The top view of FIG. 4B depicts the configuration of the antennas of the antenna system and the side view of FIG. 4C depicts the shape of the receptacle and the cross-sectional shape of a corresponding dielectric waveguide that is coupled within the receptacle 430. In this case, the dielectric waveguide has a rectangular cross-section, although other shapes are possible. The dielectric waveguide interface physically secures the dielectric waveguide to the radome of the housing without compromising radome such that the dielectric waveguide does not penetrate into the enclosed space 410 formed by the base and the radome while enabling electromagnetic coupling between the dielectric waveguide and the antenna system.

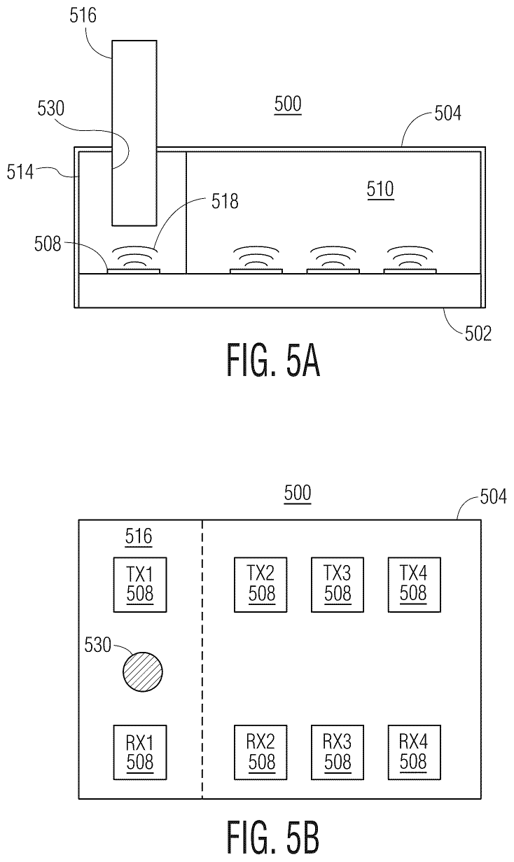

FIGS. 5A and 5B depict an example of a device 500 in which the dielectric waveguide interface 514 is integrated into a top planar surface of a radome 504. FIG. 5A is a side view of the device at a long side of the device and FIG. 5B is a top view of the device. In the example of FIGS. 5A and 5B, the dielectric waveguide interface includes a block portion of the radome that completely covers (e.g., formed directly on top of) the nearby antennas 508 (e.g., TX1 and RX1) and that includes a receptacle 530 configured to receive an end portion of a dielectric waveguide 516. The receptacle includes an opening that extends from an outer surface of the radome toward (but not to) an interior surface of the radome, and the receptacle is configured to receive an end portion of a dielectric waveguide. Additionally, the dielectric waveguide interface is configured so that the dielectric waveguide is perpendicular to a plane of the antenna system and the base 502 in contrast to the examples described with reference to FIGS. 1A-1E, 2A-2E, 3A-3C, and 4A-4C. The top view of FIG. 5B depicts the configuration of the antennas of the antenna system relative to the dielectric waveguide interface. The dielectric waveguide interface physically secures the dielectric waveguide to the radome of the housing without compromising the radome such that the dielectric waveguide does not penetrate into the enclosed space 510 formed by the base and the radome while enabling electromagnetic coupling between the dielectric waveguide and the antenna system.

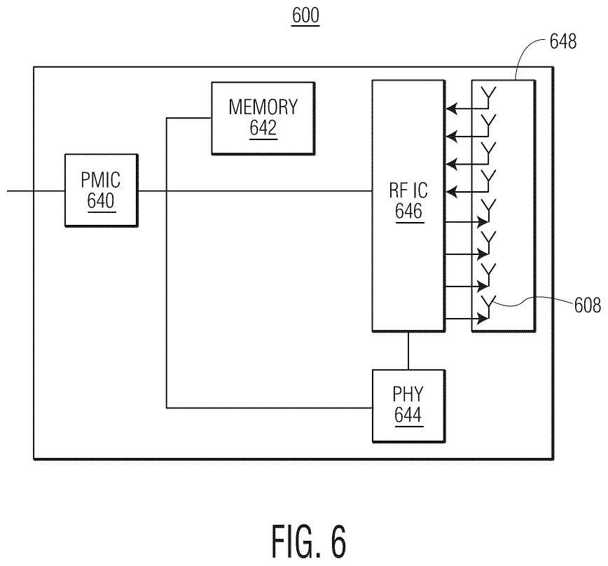

FIG. 6 is a functional block diagram of an example of components that may be included in a device 600 as described above. For example, device 600 may correspond to any of the previously-described devices 100, 101, 200, 201, 300, 400, 500. In the example of FIG. 6, the components in the device include a power management integrated circuit (PMIC) 640, memory 642, a physical layer (PHY) integrated circuit (IC) 644 (e.g., for communication), an RF front end IC 646 (RFIC), and an antenna system 648 that includes antennas 608. In an example, the components are attached to a circuit board and the circuit board is attached to a body structure, which in combination form a base.

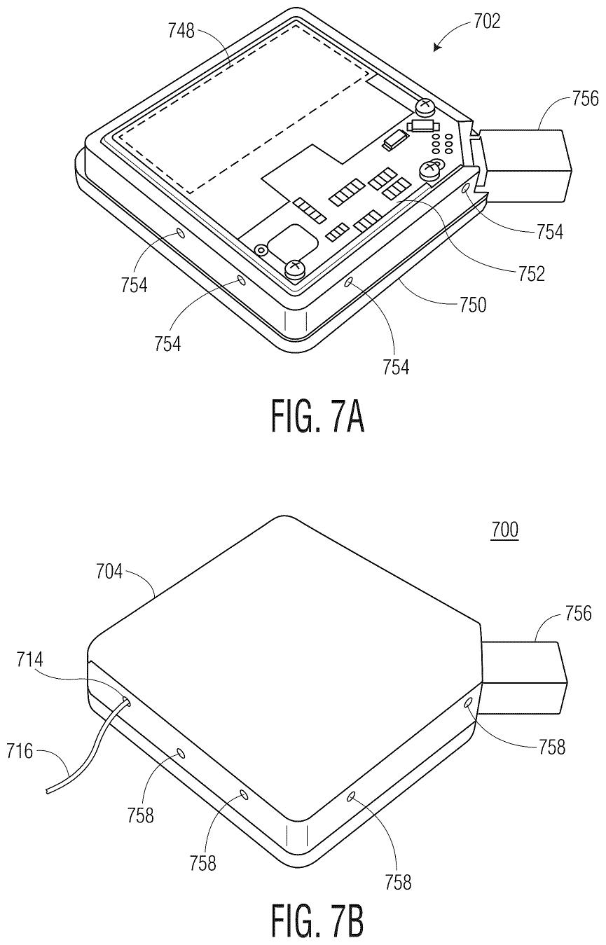

FIGS. 7A and 7B depict perspective views of an example of a device as described herein. FIG. 7A depicts a perspective view of a base 702 and an antenna system 748 without a radome attached to the base. In the example of FIG. 7A, the base includes a body structure 750 (e.g., a metallic or plastic body structure) and a circuit board 752 that includes various electronic components. For example, the circuit board includes electronic components such as those described with reference to FIG. 6. The body structure of the base also includes attachment features 754, in this case, screw receptacles, which enable a radome to be attached to the base. A connector 756 is also integrated with the base. The connector provides power and/or communications interfaces to and from the electrical components of the device. In the example of FIG. 7A, the antenna system is implemented as an array of patch or microstrip antennas that are distributed in a planar fashion over top of the circuit board.

FIG. 7B is a perspective view of the device 700 in which the radome 704 is attached to the base 702 shown in FIG. 7A. In the example, the radome has a planar shape and the radome is attached to the body of the base via screws 758 that pass through the radome and mate with corresponding screw receptacles 754 of the body structure 750. FIG. 7B also depicts a dielectric waveguide 716 that is coupled to the radome via a dielectric waveguide interface 714. For example, the dielectric waveguide interface may be similar to the dielectric waveguide interfaces described with reference to FIGS. 1A-1E, 2A-2E, 3A-3C, 4A, and 4B. In the example, of FIG. 7B, the dielectric waveguide interface is integrated into the radome at a side wall of the radome. As described herein, the dielectric waveguide interface does not compromise the radome and is configured such that the dielectric waveguide can be coupled to the radome without piercing entirely through the radome, which could compromise the integrity of the enclosure around the antenna system 748. Although the dielectric waveguide is shown as physically attached to the radome via a dielectric waveguide interface at a side surface of the radome, the dielectric waveguide could be attached to the housing (e.g., the base or the radome) at a dielectric waveguide interface that is integrated at a different location of the device, such as for example the top planar surface of the radome.

In an example, the electromagnetic energy is in a radio frequency (RF) frequency range, a gigahertz (GHz) frequency range, and/or a millimeter wave (mmWave) range. Other frequency ranges are possible.

In automotive radar systems, radars are integrated into vehicles to provide real-time detection of objects in the car's surroundings. This helps with various driver-assistance features like adaptive cruise control, collision avoidance, and parking assistance. A radome is a protective cover placed over the radar antenna. It serves as a barrier against environmental elements like rain, dirt, and debris, while allowing radar waves to pass through with minimal attenuation.

The radome is typically made of materials that are transparent to radar frequencies, such as certain plastics or composites, and is designed to prevent reflections and signal interference. However, a poorly designed radome can cause signal distortion or attenuation, which may reduce the accuracy or effective range of a radar system, impacting the performance of an automotive safety systems.

The preceding detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The connections as discussed herein may be any type of connection suitable to transfer signals or power from or to the respective nodes, units, or devices, including via intermediate devices. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. The term “coupled” or similar language may include a direct physical connection or a connection through other intermediate components even when those intermediate components change the form of coupling from source to destination.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device comprising:
a housing that forms an enclosed space;
an antenna system within the enclosed space; and
a dielectric waveguide interface configured to couple a dielectric waveguide to the housing without compromising the housing.

2. The device of claim 1, wherein the dielectric waveguide interface includes a receptacle in the housing, wherein the receptacle is configured to receive the dielectric waveguide.

3. The device of claim 1, wherein the dielectric waveguide interface includes a receptacle in the housing that is shaped similar to the dielectric waveguide.

4. The device of claim 1, wherein the housing includes a base coupled to a radome and wherein the dielectric waveguide interface includes a receptacle in the radome, wherein the receptacle is configured to receive the dielectric waveguide.

5. The device of claim 1, further including a coupling structure configured to enhance electromagnetic energy coupling between the dielectric waveguide interface and the antenna system.

6. The device of claim 1, further including a plurality of structural elements in the housing that are symmetrically positioned relative to the antenna system.

7. A device comprising:
a housing including a base and a radome coupled to the base, wherein the base and the radome form an enclosed space;
an antenna system within the enclosed space; and
a dielectric waveguide interface that is integrated with the housing and configured to receive a dielectric waveguide without compromising the housing.

8. The device of claim 7, wherein the dielectric waveguide interface includes a receptacle in the housing.

9. The device of claim 7, wherein the dielectric waveguide interface includes a receptacle in the housing that is shaped and sized to receive a dielectric waveguide.

10. The device of claim 7, wherein the dielectric waveguide interface includes a receptacle in the radome.

11. The device of claim 7, wherein the dielectric waveguide interface includes a receptacle in the radome that is shaped and sized to receive an end of a dielectric waveguide.

12. The device of claim 7, wherein the device further includes an electromagnetic energy coupling structure integrated with the housing.

13. The device of claim 7, wherein the device further includes an electromagnetic energy coupling structure integrated with the radome.

14. The device of claim 13, wherein the electromagnetic energy coupling structure includes a plurality of structural elements in the housing that are symmetrically positioned relative to the antenna system.

15. A device comprising:
a base;
an antenna system coupled to the base; and
a radome coupled to the base, wherein the base and the radome form an enclosure around the antenna system;
wherein the radome includes a dielectric waveguide interface configured to receive a dielectric waveguide without compromising the radome.

16. The device of claim 15, wherein the dielectric waveguide interface includes a receptacle in the radome.

17. The device of claim 16, wherein the receptacle includes a cavity within the radome that is configured to receive an end portion of a dielectric waveguide.

18. The device of claim 15, wherein the radome further includes an electromagnetic energy coupling structure configured to enhance electromagnetic energy coupling between the antenna system and the dielectric waveguide interface.

19. The device of claim 18, wherein the radome includes at least one additional structural element that is symmetrically positioned relative to the electromagnetic energy coupling structure and to the antenna system.
